(19) United States
(12) Patent Application Publication
(10) Pub. No.: US 2023/0014560 A1
(43) Pub. Date: Jan. 19, 2023

(54) ASSEMBLY FOR CREATING A CONDITIONED ENVIRONMENT FOR PLANTS

(71) Applicant: Paul Cain, Warrensburg, NY (US)

(72) Inventor: Paul Cain, Warrensburg, NY (US)

(21) Appl. No.: 17/543,716

(22) Filed: Dec. 6, 2021

Related U.S. Application Data
(60) Provisional application No. 63/222,967, filed on Jul. 17, 2021.

(51) Int. Cl. A01G 7/04; F16M 11/42; F16M 11/20; A47G 7/04; G05B 19/4155; H04R 1/02; H04N 5/232

(52) U.S. Cl. CPC A01G 7/045; F16M 11/42; F16M 11/2014; A47G 7/041; G05B 19/4155; H04R 1/028; H04N 5/23206; G05B 2219/49285

(57) ABSTRACT

A portable and compact assembly for providing a conditioned environment for a domestic plant both indoor and outdoor. The assembly includes a frame and a platform rotatably coupled to the frame. A plant can be placed on the platform and rotates with the platform. The assembly further includes grow lights mounted to the frame, fans mounted to the frame, and speakers. The conditioned environment can include combined exposure to grow light, sounds outputted by the speakers, and breeze generated by the fans.

### CROSS-REFERENCE TO RELATED APPLICATIONS

This application claims priority from the U.S. provisional patent application Ser. No. 63/222,967, filed on Jul. 17, 2021, which is incorporated herein by reference in its entirety.

### FIELD OF INVENTION

The present invention relates to a life support dolly for plants, and more particularly, the present invention relates to a portable assembly for growing plants in a conditioned environment.

### BACKGROUND

Plants are grown both indoors and outdoors to enhance the appearance of the space. Moreover, the plants are natural air cleansers that enrich the air with oxygen and remove carbon dioxide and volatile organic chemicals. A range of plant varieties is available that can be grown indoors and outdoors.

People love their plants and like to grow a variety of plants indoors. However, many indoor plants are delicate and require good care and a conditioned environment for growth and defense against infections. Conditioned environments, such as greenhouses are well-known for commercial farming, however, very little research is available for facilitating conditioned environments for domestic plants. Grow lights are known for irradiating domestic plants that get little sunlight. Creating and maintaining a conditioned environment of plants at home requires a lot of space, time, and labor. Owners of the plants, because of their busy lifestyle, often do not get enough time of taking care of their plants. Moreover, such a conditioned environment at home may take up a lot of otherwise limited space.

Thus, a need is appreciated for an assembly for providing a conditioned environment to enhance the growth of plants and protect the plants from infection and pests.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an assembly for plants that can provide a conditioned environment indoors for enhancing growth and deterring pests and infection.

It is another object of the present invention that the assembly is compact and portable.

It is still another object of the present invention that the assembly can fit in a standard size closet.

It is yet another object of the present invention that the assembly provides for remote monitoring of the plants.

It is a further object of the present invention that the assembly can simulate a natural conditioned environment for the plant.

It is still a further object of the present invention that the assembly can provide for increasing yield, improving quality, vitality, and health of the plants.

It is yet a further object of the present invention that different parameters of the conditioned environments can be remotely monitored and manipulated.

In one aspect, disclosed is an assembly for providing a conditioned environment for a plant, the assembly comprising a frame; a platform rotatably coupled to the frame and configured such that a plant can be placed on the platform, wherein the plant rotates with the platform; a plurality of grow lights mounted to the frame and configured to irradiate the plant on the platform; two or more fans mounted to the frame and configured to generate an air movement directed to the plant; and a control unit operably coupled to the platform, the plurality of grow lights, and the two or more fans. The assembly further comprises a plurality of wheels mounted to the frame for rolling the assembly on a floor. The frame further comprises channels for directing wastewater. The assembly further comprises a motor mounted to the frame and operably coupled to the platform for rotating the platform, wherein the motor operably coupled to the control unit. The motor is configured to rotate the platform at a speed of about 1-3 rotations per minute. The assembly further comprises one or more speakers. The assembly further comprises a camera operably coupled to the control unit, wherein a field of view of the camera configured to capture the plant. The assembly further comprises an interface for connecting to an external device, the interface coupled to the control unit, the interface comprises a USB port. The camera can be coupled to the USB port.

In one implementation of the assembly, the platform has four corners, the two or more fans comprises four fans mounted at the four corners, the plurality of wheels comprises four wheels mounted at the four corners. The control unit further comprises a network circuitry for connecting to an external computing device. The control unit is configured to receive a selection of a song from the external computing device and play the song on one or more speakers mounted to the frame and operably coupled to the control unit. The control unit is further configured to output a live video feed from the camera to the external computing device. The control unit is further configured to output a live video feed from the camera to the external computing device.

In one aspect disclosed is a method for providing a conditioned environment for a plant, the method comprises the steps of placing the plant on the platform; and creating a conditioned environment around the plant. The method further comprises the steps of receiving, one or more parameters from an external computing device, wherein the one or more parameters are for creating or manipulating the conditioned environment. The at least one parameter of the one or more parameters is a selection of a sound, wherein the control unit play the sound outputted through the one or more speakers. The method further comprises the steps of broadcasting a video feed captured by the camera to the external computing device. The method further comprises the steps of rotating the plant exposed to the conditioned environment at a predetermined speed.

In one aspect, the control unit can include a processor and a memory, wherein the memory can include a set of profiles, each profile of the set of profiles can correspond to a growth stage of a plant. The processor can select a profile stored in the memory based on the growth stage of the plant placed on the platform and process the profile for creating a conditioned environment. Each profile can include a set of parameters for the conditioned environment, such as sound, intensity and duration of sound exposure, spectrum of light and duration of exposure, breeze or wind pattern generated by the fans, and like other. In one implementation, the one or more parameters can be received from an external computing device for creating the conditioned environment or manipulating an existing parameter of a profile.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the disclosed assembly for creating a conditioned environment for domestic plants, according to an exemplary embodiment of the present invention.

FIG. 2 is a side view of the assembly, according to an exemplary embodiment of the present invention.

FIG. 3 is another perspective view of the assembly, according to an exemplary embodiment of the present invention.

FIG. 4 is an enlarged view of a corner of the assembly, according to an exemplary embodiment of the present invention.

FIG. 5 is another perspective view showing four fans, according to an exemplary embodiment of the present invention.

FIG. 6 is a block diagram showing an exemplary embodiment of the control unit connected to a smartphone via an external network, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is an assembly for creating a conditioned environment indoors that can boost the growth of normal and weak plants and protect the plants against plant infections and pests. The disclosed assembly exposes the plants to stimulating grow lights, soundwaves, and wind while rotating the plant for uniform exposure, simulating a natural growth environment. The disclosed assembly combines the use of sound waves operating between 0.1 kHz to 100 decibels, grow light waves, and fans to invigorate plant growth.

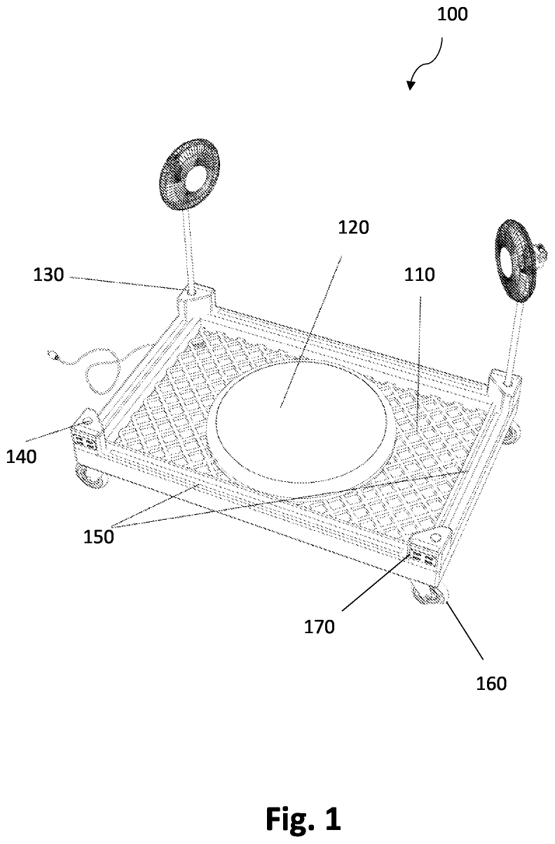

The disclosed assembly can generate a conditioned environment, both indoor and outdoor, for cellular stimulation by exposing the plants to grow lights and sound waves. Sound waves can also be delivered directly to the roots and foliage to promote growth. Moreover, a windy environment can also be simulated around the plants for strengthening the root system. Referring to FIGS. 1-4 which shows different views of the disclosed assembly 100 for providing a conditioned environment to a domestic plant. The disclosed assembly 100 can include a frame 110 and a platform 120 rotatably mounted to the frame 110. The platform can be similar to a turntable/carousel that can be rotated at a desired speed. A suitable motor can be provided to rotate the platform 120, wherein the motor can be mounted to the frame and operably coupled to the platform 120. On the platform can put the plants and the platform can rotate the plants at a predetermined speed. The frame can include suitable channels or mesh to allow any wastewater to collect through the channels into a reservoir or drip through the mesh onto a floor. The frame can be made from a durable and rigid material, such as plastic or metal or a combination thereof. The metal if used can include alloys, preferably light-weight metals can be used. The size and shape of the frame and the platform can be varied, and any such variation is within the scope of the present invention. For example, the frame can be round and the platform can be square, or both the platform and the frame can be round or square.

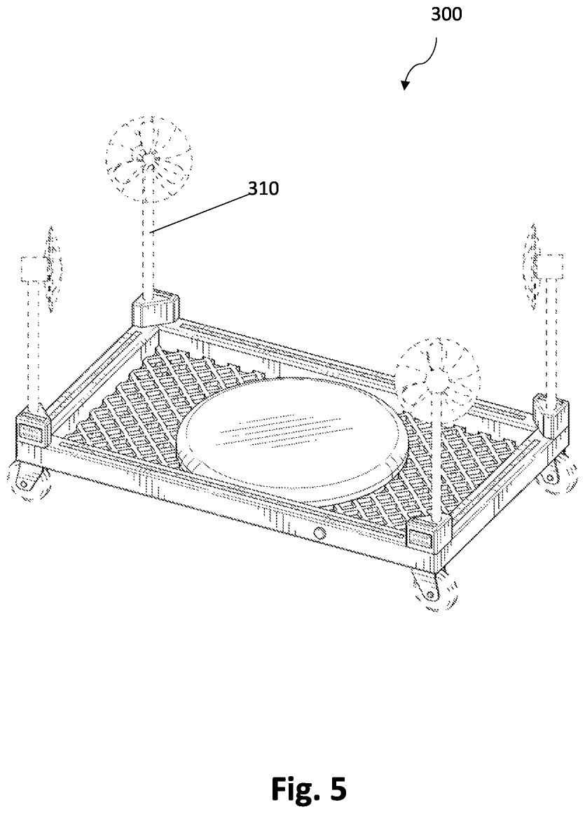

The frame 110 at the corners or the periphery can include fans for simulating wind or breeze directed to the plant. More than one fan can be used to generate a breeze or wind in a predetermined pattern directed to the plant placed on the platform. The pattern can include the speed and the direction of the air, and variations in the speed and the direction over a period. The platform can include attachment points for mounting the fans to the frame. FIG. 1 shows the attachment point 140 for the fan 130. FIG. 1 shows two such fans while FIG. 5 shows an assembly 300 having four fans 310 at four corners of the frame.

Suitable grow lights 150 can also be disposed on the frame such that to irradiate the plant out on the platform. The grow lights can be fluorescent, LEDs or any grow light known to a skilled person for use in plants. The grow lights can be switched between different intensity or wavelength ranges, such as red or blue, the plants can be exposed to the light of the desired wavelength that may be suitable for the growth stage of the plant. For example, during the vegetation stage, light in the blue spectrum can be used to accelerate growth.

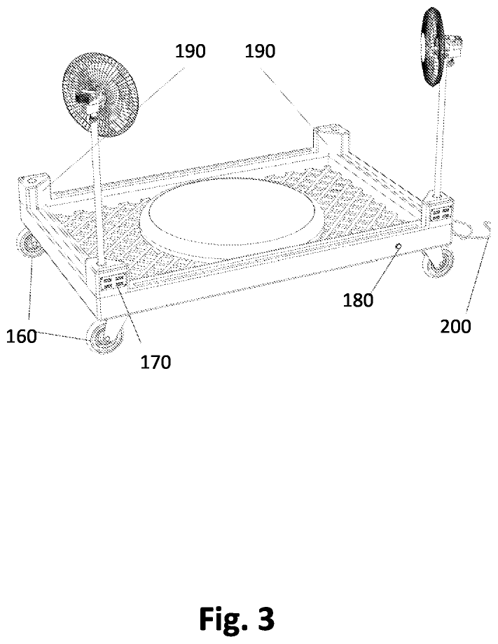

The frame 110 can be mounted on wheels 160 that allows the assembly 100 to be easily rolled on the floor for moving the assembly 100 from one place to another. FIG. 1 shows four steel full swivel ball-bearing rubber wheels at four corners of the frame. The minimum number of wheels may depend on the size of the assembly and three or more wheels are within the scope of the present invention. Speakers can also be incorporated for outputting the soundwaves to the plants placed on the platform. The sounds can be of the rain, breeze, birds chirping, and the like sounds common in the natural environment of the plant. It is known that certain sounds are directional, and so the speakers can be positioned such that to direct the sound waves to the plants, including the roots of the plants, placed on the platform. FIG. 3 shows the speakers 190 at corner posts of frame 110. The speakers can be water-proof and dust-proof, and suitable for outdoor use. The speakers with wireless connectivity, such as Bluetooth speakers are within the scope of the present invention. Also, Buzzy Balls are known in the art which are small, waterproof LED disco balls with a speaker. The Buzzy Balls are wireless and rechargeable. It is understood that the disclosed assembly can include a suitable power supply and the different components of the assembly can be powered by the same or different power supply. FIG. 3 shows an electric cord 200 of the power supply that can be connected to a wall electrical socket. Batteries, such as rechargeable lithium-ion batteries can also be incorporated without departing from the scope of the present invention.

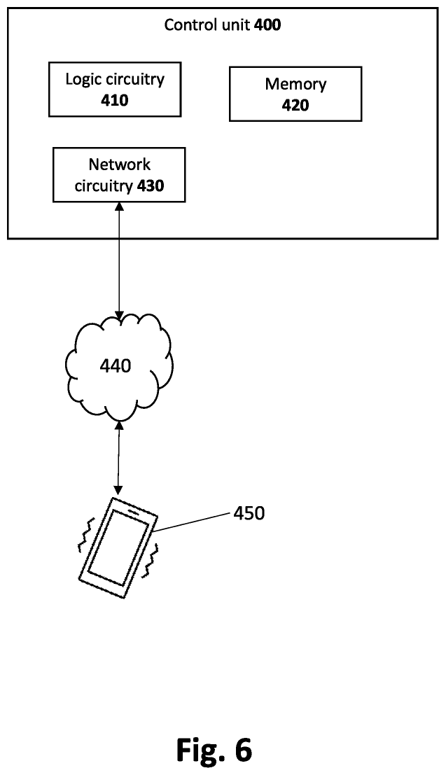

Referring to FIG. 6, the disclosed assembly 100 can also include a control unit 400 for controlling different components including the grow lights, sounds, and fan. The control unit 400 can receive and control different parameters of the conditioned environment, such as the duration for lights, fan speed, sound waves, and like. The control unit 400 can include a logic circuitry 410 and a memory 420. The logic circuitry 410 can include a microprocessor that responds to and processes instructions fetched from the memory. The control unit 400 can include a network circuitry 430 for connecting to an external network 440, such as Wi-Fi or Bluetooth®. It is understood, however, that any known network either wired or wireless, and different network protocols for establishing the connection between two computing devices known to a skilled person are within the scope of the present invention. In one implementation, the control unit can connect to a home wireless local area network through a router. Those skilled in the art will recognize the control unit may indirectly connect to the external computing device through multiple relay nodes such as access points, base stations, hubs, bridges, routers, or other communication devices known to a skilled person and not described or shown herein. The control unit 400 through the network 440 can remotely connect to an external computing device 450, such as a smartphone, a smartwatch, tablet computer, laptop, thin client, desktop, workstation, and the like computing device that has a network circuitry for connecting to the external network. Application software can be provided for the external computing device configured to allow the external computing device to interact with the disclosed control unit. An interface can be implemented on the external computing device by execution of the application software, wherein the user can interact with the disclosed assembly and control different functions. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS.

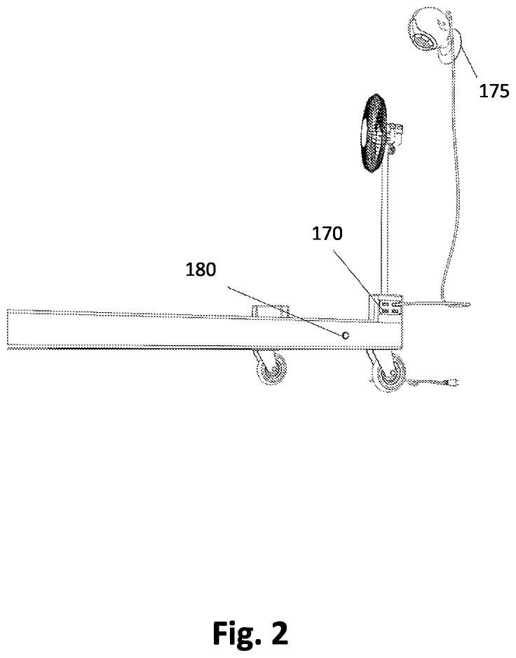

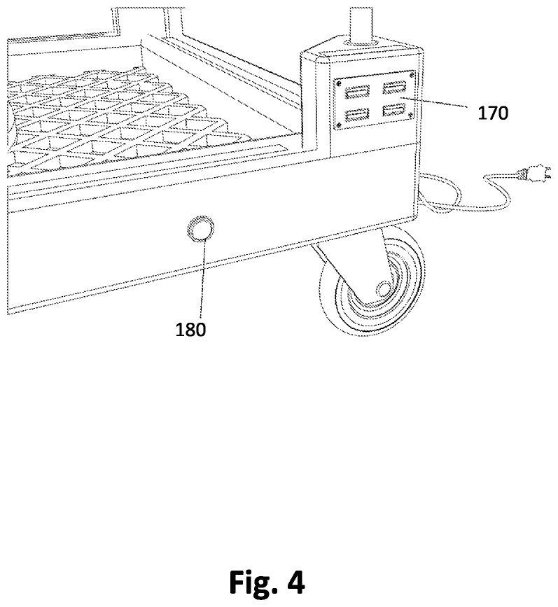

Refereeing to FIG. 4, which shows an interface 170 that can be operably connected to the control unit 400 for connecting additional devices, such as a camera. For example, the interface can include USB ports that allow connecting an additional device, memory drive, and the like. FIG. 2 shows a camera 175 that can be mounted nearby the assembly 100 and connected to the control unit 400 through the interface 170. It is understood that the camera can also be wirelessly coupled to the control unit, such as through Wi-Fi. A button 180 can also be seen in FIG. 3 that can be actuated to connect to the external network. Suitable LED indicators can also be provided to show the status of the assembly, such as network connection status, power status, and the like. The camera or the control unit can also include an option to record video on internal memory or external memory. Through the camera, a user can remotely watch their plants on the platform at any time and from anywhere. The camera can be zoomed in and out for an enlarged view of the plant, such as to inspect the leaves. In one implementation, the disclosed control unit can also allow the user to remotely play a song.

In one aspect, disclosed is a method for implementing a conditioned environment of domestic plants, both indoor and outdoor. The method includes the steps of profiling the growth stages of the plans based on theoretical and technical knowledge available to a skilled person. In one implementation, profiles can be created for the three growth phases i.e., vegetation stage, bloom stage, and the harvest stage. For the vegetation stage, the combined high blue spectrum of LED light and the sound of rain and babbling brook can be incorporated in the profile. For the bloom stage, a full spectrum LED combined with the sound of bees buzzing and birds chirping can be incorporated. For the harvest mode, LED light high red combined with the sound of bugs chewing can be incorporated. It is understood that aforesaid profiles are only examples, and specific profiles can be created for each plant considering the requirement and natural growing environment of the plant. Moreover, the profile may contain numerous parameters for optimizing each condition, such as sound and intensity of sound, intensity and duration of light exposure, wind speed, and the like. The disclosed method can include the steps of defining such parameters directly or remotely by the owner or any person. The profiles can be preconfigured and directly downloaded to a memory of the control unit.

In one implementation, there can be three settings for the grow light combined with sound recordings according to the phase of plant growth. The four fans can operate to generate a breeze or wind pattern for air distribution, stimulate and strengthen root growth, and decrease mold and pests. Also, the users can upload and play their music via Bluetooth, and stream music through the internet. The setting can be optimized for stimulating earlier flowering cycle, increasing messenger RNA, strengthening resistance to diseases, increasing the yield at harvest time, and increasing the terpene levels, providing LED supplemental up lighting and necessary light below the canopy for maximum yield in lower-level growth. The profiles created according to the growth phase can be optimized to excites the cellular activity causing increased photosynthesis and promoting larger root growth. The natural growing environment of the plants can be simulated by creating recordings of the sounds common in the ordinary favorable environment for the plant, such as the sound of rain, insects chewing, and the like. The disclosed assembly can help strengthen the plants from early development and help the weak or dying plant to recover. Moreover, the user can remain in touch with their plants remotely from anywhere and anytime, and control different features such as watering the plants or can view preprogrammed actions performed by the assembly. The users can interact with their plants for mutual happiness and vibrancy.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An assembly for providing a conditioned environment for a plant, the assembly comprising:
a frame;
a platform rotatably coupled to the frame and configured such that a plant can be placed on the platform, wherein the plant rotates with the platform;
a plurality of grow lights mounted to the frame and configured to irradiate the plant on the platform;
two or more fans mounted to the frame and configured to generate an air movement directed to the plant; and
a control unit operably coupled to the platform, the plurality of grow lights, and the two or more fans.

2. The assembly according to claim 1, wherein the assembly further comprises a plurality of wheels mounted to the frame for rolling the assembly on a floor.

3. The assembly according to claim 1, wherein the frame further comprises channels for directing wastewater.

4. The assembly according to claim 1, wherein the assembly further comprises a motor mounted to the frame and operably coupled to the platform for rotating the platform, wherein the motor operably coupled to the control unit.

5. The assembly according to claim 4, wherein the motor is configured to rotate the platform at a speed of about 1-3 rotations per minute.

6. The assembly according to claim 1, wherein the assembly further comprises one or more speakers.

7. The assembly according to claim 2, wherein the frame has four corners, the two or more fans comprises four fans mounted at the four corners, the plurality of wheels comprises four wheels mounted at the four corners.

8. The assembly according to claim 1, wherein the assembly further comprises a camera operably coupled to the control unit, wherein a field of view of the camera configured to capture the plant.

9. The assembly according to claim 8, wherein the assembly further comprises an interface for connecting an external device, the interface coupled to the control unit, the interface comprises a USB port.

10. The assembly according to claim 9, wherein the camera is coupled to the USB port.

11. The assembly according to claim 9, wherein the control unit further comprises a network circuitry for connecting to an external computing device.

12. The assembly according to claim 11, wherein the control unit is configured to receive a selection of a song from the external computing device and play the song on one or more speakers mounted to the frame and operably coupled to the control unit.

13. The assembly according to claim 12, wherein the control unit is further configured to output a live video feed from the camera to the external computing device.

14. The assembly according to claim 12, wherein the one or more speakers are dustproof and soundproof.

15. A method for providing a conditioned environment for a plant, the method comprises the steps of:
providing an assembly comprising:
a frame,
a platform rotatably coupled to the frame and configured such that a plant can be placed on the platform, wherein the plant rotates with the platform,
a plurality of grow lights mounted to the frame and configured to irradiate the plant on the platform,
two or more fans mounted to the frame and configured to generate an air movement directed to the plant,
one or more speakers mounted to the frame, and
a control unit operably coupled to the platform, the plurality of grow lights, the two or more fans, and the one or more speakers;
placing the plant on the platform; and
creating a conditioned environment around the plant.

16. The method according to claim 15, wherein the method further comprises the steps of:
receiving, one or more parameters from an external computing device, wherein the one or more parameters are for creating or manipulating the conditioned environment.

17. The method according to claim 16, wherein at least one parameter of the one or more parameters is a selection of a sound, wherein the control unit play the sound outputted through the one or more speakers.

18. The method according to claim 16, wherein the assembly further comprises a camera operably coupled to the control unit, wherein a field of view of the camera configured to capture the plant, the method further comprises the steps of:
broadcasting a video feed captured by the camera to the external computing device.

19. The method according to claim 15, wherein the method further comprises the steps of:
rotating the plant exposed to the conditioned environment at a predetermined speed.
